(19) United States
(12) Patent Application Publication
(10) Pub. No.: US 2008/0269100 A1
(43) Pub. Date: Oct. 30, 2008

(54) Layered Silicate Slurries Having a High Solids Content

(75) Inventors: Ulrich Sohling, Freising (DE); Friedrich Ruf, Ast (DE); Anna Held, Moosburg (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: SUD-CHEMIE AG, Munchen (DE)

(21) Appl. No.: 11/994,676

(22) PCT Filed: Jul. 4, 2006
(86) PCT No.: PCT/EP2006/006467

§ 371 Date: Apr. 29, 2008

(30) Foreign Application Priority Data
Jul. 4, 2005 (DE) 10 2005 031 176.8

(51) Int. Cl. C08K 3/34; D21H 17/63; C11D 17/08

(52) U.S. Cl. 510/418; 524/442; 524/456; 524/445; 524/447; 162/168.1; 510/527

(57) ABSTRACT

What is described is a slurry comprising (a) at least 10% by weight of at least one sheet silicate, based on the total weight of the slurry; (b) an aqueous suspension medium and (c) a dispersing aid selected from at least one polyethylene glycol having a mean molecular weight of less than 90 000 and/or at least one polyacrylic acid in free acid form. Also described is a process for producing the slurry and the preferred used thereof.

The present invention relates to a slurry composed of sheet silicates which has a high solids content, to a process for its production and to its use.

For some industrial applications, sheet silicates, for example bentonites, are preferably metered in in dispersed form. This is the case, for example, in papermaking with regard to contaminant binding or in the case of application in washing composition formulations. For instance, bentonite is used as a so-called retention aid during the papermaking process.

The addition of bentonite to pulverulent washing composition formulations serves to increase the softness of the laundry. This concept has also been extended to liquid washing compositions, in which an increase in the softness of the laundry is likewise intended by virtue of addition of bentonite.

For the industrial applications described above, it is of interest to provide bentonite in dispersed form such that the solids content of the bentonite in the aqueous suspension or colloidal solutions is particularly high. A preparation of such highly concentrated slurries is, however, not possible directly because, for example, bentonites typically form gels in aqueous colloidal solution. This effect is used, among other applications, also industrially in the case of use of the bentonites in thickeners. The mechanisms of gel formation in bentonite are described, inter alia, in the publication by S. Abend and G. Lagaly, Applied Clay Science 16 (2000) p. 201-227.

U.S. Pat. No. 5,484,834 discloses a liquid bentonite slurry which comprises water, a polyacrylate and a sodium salt of silica. The bentonite slurry further comprises a sulfonate in an amount of 10-30% by weight. As a result of the high concentration of dispersant, which is between 10 and 30%, and the presence of sodium silicate, which alkalizes the slurry, they cannot be used for formulations whose pH values are in the neutral range.

WO 93/22254 discloses concentrated bentonite slurries and a process for their production. In this case, at least 8% by weight of bentonite is present dispersed in the concentrated aqueous bentonite slurry. The low viscosity is established by adding salts. The first salt comprises sodium and lithium compounds with anions from the group of chloride, carbonate, nitrate, citrate, sulfate, acetate or phosphate, which are added individually or in combination. The second salt component comprises potassium salts, and anions from the group of chloride, carbonate, nitrate, citrate, sulfate, acetate or phosphate, or sodium silicate, sodium pyrophosphate or a sodium polyacrylate with a low molecular weight. Such a formulation has the disadvantage that it is not compatible with liquid washing composition formulations because the high proportion of electrolytes can destroy or influence the gel phases.

EP 0 485 124 A1 discloses a bentonite swelling clay which is used for the papermaking process as a liquid concentrate with at least 15% bentonite. The high concentration of the bentonite is achieved by an electrolyte addition. The electrolytes used are salts of monovalent ions, especially sodium and ammonium salts. They are those from the group of the chloride, sulfate or carbonate compounds. Slurries having a bentonite concentration of 9-30% by weight can be established. For use in the field of papermaking, these slurries have to be diluted later. In the electrolytes, predominantly sodium or ammonium salts of the corresponding chloride, sulfate or carbonate compound are used. Use is possible only in the field of papermaking, but not in washing compositions.

WO 95/09135 discloses a stabilized highly concentrated smectite slurry having a low viscosity and a production process therefor. This slurry contains between 10 and 47% by weight of a smectitic clay. As a result of the addition of low molecular weight amines (at least 0.3% by weight), the swelling of the clay is prevented and the solids content of the slurry is increased. The use of such amines restricts the application of this slurry because the amines can have interactions with the anionic surfactant system. For introduction of a bentonite slurry into washing composition formulations, it would therefore be advantageous to work without amine. WO 95/09135 describes mainly uses with regard to papermaking and/or as a thickener.

The slurries described in the prior art, however, have disadvantages, such that there is a constant need for improved slurries with a high sheet silicate content and good storage stability.

It was thus an object of the present invention to develop additive designs for the production of highly concentrated slurries which are usable for a multitude of sheet silicate types such as bentonites, e.g. calcium bentonites, magnesium bentonites and mixed calcium sodium bentonites, and are suitable for producing slurries with long-term storage stability. It is also an object of the present invention to provide a slurry composed of sheet silicates with a high solids content, which avoids the disadvantages of the prior art.

In a first aspect of the invention, this object is achieved by a slurry comprising

a) at least 10% by weight of at least one sheet silicate, based on the total weight of the slurry;

b) an aqueous suspension medium;

c) a dispersing aid selected from at least one polyethylene glycol having a mean molecular weight of less than 90 000 and/or at least one polyacrylic acid in free acid form.

It has thus been found that, surprisingly, the above dispersing aids in slurries with a high content (10% by weight or more) of sheet silicate allow the problems of a viscosity rise or gel formation which occur in the prior art to be avoided, and storage-stable highly concentrated slurries to be provided.

More preferably, the slurry, apart from components a), b) and c), does not have a component comprising monovalent metal cations. Thus, one aspect of the invention is based, inter alia, on the finding that the use of salts for lowering the viscosity, especially of lithium and sodium salts, is problematic in the case of dispersion of sheet silicates such as bentonites, especially in the calcium and/or magnesium form, and of sheet silicates with a high calcium and/or magnesium content. When monovalent ions are added here to the dispersion, a rise in the viscosity initially takes place, which is caused by the monovalent ions activating the bentonite as a result of an exchange for the divalent intermediate layer cations. The use of alkali metal salts of polyacrylates, as described, for example, in WO 95/09135, in such a case also likewise does not lead to the aim because activation occurs as for the simple inorganic salts. Thus, although it is initially found that low-viscosity slurries are formed when alkali metal salts of polyacrylates are used for the dispersion of bentonites, they have thickened to a macroscopic gel after a storage time of 1-3 days.

In the context of the present invention, it is generally possible to use any sheet silicate. Such sheet silicates are familiar to those skilled in the art. Sheet silicate may, for example, be a natural or synthetic two-layer or three-layer silicate. The three-layer silicates used may be those from the group of the smectites (such as montmorillonite, hectorite, antigorite, nontronite, beidellite or saponite), vermiculites, illites or micas.

Other usable sheet silicates are sepiolite, attapulgite (palygorskite), stevensite or chlorite. Among the montmorillonite-containing minerals, mention should be made especially of bentonite and fuller's earth, which, according to their source, may be of different composition.

The sheet silicate may be chemically and/or thermally modified. A chemical modification is understood to mean especially an activation with inorganic and/or organic acids. Among the inorganic acids, mention should be made, for example, of hydrochloric acid, phosphoric acid or sulfuric acid.

Thermal treatment includes drying and optionally calcining. This thermal treatment can be effected under oxidizing or reducing conditions.

In a preferred embodiment of the invention, the sheet silicates are at least one smectitic sheet silicate. Preference is also given to using sheet silicates from the group of bentonite, hectorite, saponite or beidellite.

In a particularly preferred embodiment of the invention, the sheet silicate used is a sheet silicate containing divalent cations, especially alkaline earth metal cations such as calcium and/or magnesium ions. What should be understood by this is familiar to those skilled in the art. The presence of divalent cations in the sheet silicate can be determined, for example, by elemental analysis. In a particularly preferred embodiment, the sheet silicate is a calcium-containing sheet silicate.

In a further preferred embodiment, some of the cation exchange capacity (CEC) is formed by divalent or polyvalent cations, especially alkaline earth metal cations such as calcium and/or magnesium ions, especially calcium ions. Processes for determining the CEC and the individual ion contents are specified below.

It has thus been found that, surprisingly, the problems of a rise in viscosity or gel formation which occur in the prior art in the case of such sheet silicates can be avoided, and storage-stable, highly concentrated slurries can be provided.

In a further preferred embodiment of the invention, the at least one sheet silicate is a swellable sheet silicate. The swellability of the at least one sheet silicate is preferably at least 4 ml/2 g. The swellability can be determined as specified in the method part which follows. It should be noted that, for example, (pure) calcium- or magnesium-containing sheet silicates are also swellable. Exchange of divalent intermediate layer cations for monovalent cations causes the sheet silicate to swell in aqueous suspensions or slurries.

It is also possible to use two or more sheet silicates for the slurry. The expression “slurry” is understood in a broad sense in the context of the present invention and is understood to mean any dispersion or suspension of at least one sheet silicate in a liquid medium.

In the context of the present invention, in a first aspect, it has been found that the use of at least one polyethylene glycol with quite a low molecular weight, as described herein, can afford a highly concentrated and highly storage-stable slurry of the at least one sheet silicate.

In a second aspect of the present invention, it has also been found that the use of at least one polyacrylic acid in the acid form (protonated form) can also afford highly concentrated slurries with very good storage stability.

As mentioned above, no components containing monovalent metal cations (or ammonium ions) are added to components a), b) and c) in the production of the (concentrated) slurry. The aqueous suspension medium (component b)) preferably also does not contain any monovalent metal cations (or ammonium ions). The same preferably applies to the dispersing aid itself (component c)). It has been found that, surprisingly, this allows high swelling and gelation of the at least one sheet silicate to be avoided. Advantageously, the inventive slurry provides sheet silicates such as bentonites in storage-stable form in highly concentrated aqueous dispersion, while the dispersions are still pumpable and the viscosity behavior remains storage-stable within a period of days and weeks.

In the context of the invention, it has also been found that the slurries have particularly advantageous (low) viscosities and a high storage stability when the pH of the slurry is between about 4 and 10, especially between about 5.5 and 9, more preferably between about 6 and 9, especially preferably between about 6.5 and 8.5. When this pH does not arise immediately by slurrying of the at least one sheet silicate in the aqueous suspension medium, optionally after addition of the dispersing aid (component c)), the above preferred pH ranges can be established by the addition of at least one acid. It is possible here in principle to use any inorganic or organic acid. In particular, it is possible, without any restriction thereto, to use mineral acids, for example hydrochloric acid, sulfuric acid, phosphoric acid or nitric acid. Among the organic acids, mention may be made, for example, of citric acid, oxalic acid, formic acid, acetic acid and the like. Particular preference is given to using hydrochloric acid.

In a preferred embodiment of the invention, the acids used are those whose anions have poor complexing action, if any, on Ca²⁺ or Mg²⁺. As a result, it is possible to further minimize leaching of Ca²⁺ or Mg²⁺ out of the sheet silicate and hence activation or thickening in the slurry.

According to the invention, it is also preferred that, when an acid is added, the acid for establishing the intended pH is initially charged in the aqueous suspension medium, and then the at least one sheet silicate is added.

In a preferred embodiment of the invention, the slurry has a content of monovalent metal cations (and ammonium ions) of less than about 0.5% by weight, especially less than 0.1% by weight, preferably less than 0.05% by weight, more preferably less than 0.01% by weight, not including the ion content of the at least one sheet silicate here. It has been found that, surprisingly, such a (low) content of monovalent metal cations (and ammonium ions) enables a low viscosity at high sheet silicate concentrations and a particularly good storage stability. In a particularly preferred embodiment, the inventive slurry, apart from component a), does not comprise any component comprising monovalent metal cations (and ammonium ions), not taking account of customary impurities with the above cations, especially sodium ions in commercial products which are used in accordance with the invention as a dispersion aid (component c)). In a further preferred embodiment of the present invention, it has been found that the dispersing aids used in accordance with the invention provide particularly favorable results when the proportion of divalent cations in the CEC of the at least one sheet silicate is at least 35%, especially at least 40%.

In addition, it is preferred in accordance with the invention that the divalent cations of the at least one sheet silicate are calcium and/or magnesium ions. In addition, it is preferred that the proportion of monovalent metal cations (and ammonium ions), especially sodium ions, in the CEC of the at least one sheet silicate is less than about 65%.

In yet a further preferred embodiment of the invention, the CEC of the at least one sheet silicate is more than 70 meq/100 g, preferably at least 75 meq/100 g. A process for determining the CEC is specified below.

According to the invention, it is possible to prepare highly concentrated slurries of the at least one sheet silicate. The content in the slurry of the at least one sheet silicate is preferably more than 10% by weight, especially more than 15% by weight, more preferably more than 20% by weight, even more preferably more than 30% by weight, especially preferably more than 40% by weight.

According to the invention, the aqueous suspension medium used is more preferably water. However, other aqueous suspension media are also conceivable, for example aqueous alcoholic solution or a glycol-containing aqueous solution.

In one aspect of the present invention, at least one polyethylene glycol (polyglycol) with relatively low mean molecular weight is used as the dispersing aid. It has thus been found that, surprisingly, when such polyethylene glycols having a relatively low mean molecular weight are used, it is possible to obtain slurries having a relatively high content (10% by weight or more) of sheet silicate which avoid the problems of a rise in viscosity or gel formation and enable storage-stable highly concentrated slurries. This is not possible with polyethylene glycols having a significantly higher mean molecular weight, for example more than 100 000, which are used as flocculants (and specifically not as dispersants) in the prior art. Such flocculants are used in order to combine individual sheet silicate particles via a so-called “bridging flocculation”, and thus increase the viscosity. In a particularly preferred embodiment of the invention, at least one polyethylene glycol having a mean molecular weight of less than about 80 000, especially less than about 70 000, especially between about 200 and about 50 000, preferably between about 2 000 and 20 000, more preferably between about 4 000 and 15 000, more preferably between about 4 000 and 12 000, is therefore used.

When, in a further aspect of the present invention, at least one polyacrylate is used as a dispersing aid, it is more preferably at least one polyacrylate having a mean molecular weight between about 100 and 100 000, more preferably between about 200 and about 70 000, especially between about 200 and 50 000.

In a preferred embodiment of the invention, the at least one polyethylene glycol is used in an amount between about 0.1 to 10% by weight, especially from about 2 to 8% by weight, based in each case on the at least one sheet silicate. In individual cases, however, smaller or greater amounts may also be advisable.

In a further preferred embodiment, the at least one polyacrylic acid (in the acid form) is used in an amount between about 0.1 to 10% by weight, preferably between about 1 to 6% by weight, based in each case on the at least one sheet silicate. Here too, however, smaller or greater amounts of at least one polyacrylic acid may also be advisable in individual cases.

As already detailed above, in the context of the present invention, it has been found that, surprisingly, in contrast to the (electrolytic) dispersing aids and compositions containing monovalent metal cations described in the prior art, the inventive dispersing aids can be used particularly advantageously to produce highly concentrated and storage-stable slurries.

A further aspect of the present invention relates to a process for producing a slurry as described herein. In this process, at least one sheet silicate is initially provided, preferably in particle or powder form. Additionally provided are an aqueous suspension medium as described above and a dispersing aid as described above. The inventive slurry is then prepared by mixing the above components (components a)-c)). It has been found that, surprisingly, particularly storage-stable slurries can be produced when the at least one dispersing aid is first initially charged in the aqueous suspension medium and the at least one sheet silicate is then added. In addition, to obtain particularly storage-stable slurries, it is preferred that, when an acid is used to establish the above-described preferred pH range, it is initially charged in the aqueous suspension medium before the at least one sheet silicate is added.

A further aspect of the present invention relates to the use of at least one polyethylene glycol as described herein and/or of at least one polyacrylic acid in the acid form (protonated form) as described herein as a dispersing aid for at least one sheet silicate, especially at least one calcium-containing and/or magnesium-containing sheet silicate.

The present invention further provides for the use of the slurries, especially having a content of sheet silicate of at least 10% by weight. They are usable especially for washing and cleaning compositions, for example the introduction of the bentonite into liquid washing composition formulations or liquid fabric softener formulations. In addition, in a further use of the slurries in accordance with the invention can be used for the paper applications, and here especially in the field of contaminant control and of retention aids. However, further applications of the inventive slurry in other fields in which the use of highly concentrated sheet silicate slurries is advantageous are also conceivable and embraced by the present invention. In a further use in accordance with the invention, the slurries are replaced in all fields in which sheet silicates such as bentonites are used as sorbents or adsorbents or thickeners. The invention will now be illustrated in detail with reference to the nonrestrictive examples which follow.

### EXAMPLES

### Test methods

### Determination of the Cation Exchange Capacity (CEC)

Principle: The clay is treated with a large excess of aqueous NH₄Cl solution and extracted by washing, and the amount of NH₄⁺ remaining on the clay is determined by means of elemental analysis.

Me⁺(clay)⁻+NH₄⁺______NH₄⁺(clay)⁻+Me⁺

(Me⁺=H⁺, K⁺, Na⁺, ½ Ca²⁺, ½ Mg²⁺ . . . .)

Equipment: screen, 63 μm; Erlenmeyer flask with ground-glass joint, 300 ml; analytical balance; membrane suction filter, 400 ml; cellulose nitrate filter, 0.15 μm (from Sartorius); drying cabinet; reflux condenser; hotplate; distillation unit, VAPODEST-5 (from Gerhardt, No. 6550); standard flask, 250 ml; flame AAS

Chemicals: 2N NH₄Cl solution; Nessler's reagent (from Merck, Art. No. 9028); 2% boric acid solution; 32% sodium hydroxide solution; 0.1 N hydrochloric acid; 0.1% NaCl solution; 0.1% KCl solution.

Procedure: 5 g of clay are screened through a 63 μm screen and dried at 110° C. Thereafter, exactly 2 g are weighed into the Erlenmeyer flask with a ground-glass joint by difference weighing on the analytical balance and admixed with 100 ml of 2 N NH₄Cl solution. The suspension is boiled under reflux for one hour. In the case of bentonites with a high CaCO₃ content, ammonia may be evolved. In these cases, NH₄Cl solution has to be added until no ammonia odor is perceptible any longer. An additional check can be carried out with a moist indicator paper. After a duration of approx. 16 h, the NH₄⁺ bentonite is filtered off through a membrane suction filter and washed with demineralized water (approx. 800 ml) until it is substantially free of ions. The proof that the washing water is free of ions is carried out on NH₄⁺ ions with the Nessler's reagent which is sensitive therefor. According to the clay type, the number of washes may vary between 30 minutes and 3 days. The extractively washed NH₄⁺ clay is removed from the filter, dried at 110° C. for 2 h, ground, screened (63 μm screen) and dried once again at 110° C. for 2 h. Thereafter, the NH₄⁺ content of the clay is determined by means of elemental analysis.

Calculation of the CEC: The CEC of the clay was determined in a conventional manner via the NH₄⁺ content of the NH₄⁺ clay, which had been determined by means of elemental analysis of the nitrogen content. To this end, the Vario EL 3 instrument from Elementar-Heraeus, Hanau, Germany, was used according to the manufacturer's instructions. The data are in meq/100 g of clay.

Example: nitrogen content=0.93%;

molecular weight: N=14.0067 g/mol

$$C E C = \frac{0.93 \times 1000}{14.0067} = 66.4 meq \text{/} 100 g$$

CEC=66.4 meq/100 g of NH₄⁺ bentonite

### Determination of the Swelling Volume

The swelling volume is determined as follows:

A calibrated 100 ml measuring cylinder is filled with 100 ml of dist. water. 2.0 g of the substance to be analyzed are added slowly to the water surface in portions from 0.1 to 0.2 g. After the material has sunk, the next quantum is added. After waiting for 1 hour after the addition has ended, the volume of the swollen substance is then read off in ml/2 g.

### Viscosity Measurements

Viscosity measurements carried out below were performed with a Brookfield Digital Viskometer Model DV II (Brookfield, Stoughton, Mass. 02072, USA). The data (for example in mPas) regarding the spindles and rotational speeds used are each cited in the examples.

### Production of the Slurry

To this end, a PENDRAULIK stirrer (FH Pendraulik Springe, Germany) was used. The additives were each initially stirred into the water. The bentonite was then stirred in with the Pendraulik stirrer at setting 1 (930 rpm) for up to 5 min. Stirring was then continued at setting 1.5 (15 rpm) for 5 min. The slurries were normally produced in 800 ml beakers. In the batches of 500 ml, small toothed disks (diameter 40 mm) were used as the stirring tool. In the batches of 5 l, a dissolver disk of diameter 55 mm was used as the stirring tool. A 10 l bucket was used.

### Inventive Additives

Polyethylene glycols 1500, 4000, 6000, 20000 were purchased from CLARIANT, Frankfurt under the trade name Polyglykol. Alternatively, polyethylene glycols from BASF were also used, which are sold under the tradename Pluriol. The manufacturers of the individual PEGs are specified in each case in the examples. As a typical suitable protonated acrylate, Sokalan CP 10S from BASF AG Ludwigshafen was used. This was present as a 40% by weight solution.

### Other Additives and Chemicals

Hydrochloric acid: 0.5M, Riedel de Haen or Merck Dispex® N40, A40: Dispersing assistant from Ciba, Grenzach (aqueous solutions are used as purchased from the manufacturer).

### Example 1

For the slurry production, a bentonite (bentonite 1) with the following properties was used:

| Property | Value |
|---|---|
| Montmorillonite content (methylene | 75% |
| blue method) | |
| Secondary mineral content (X-ray | <5% by wt. |
| measurements) | |
| Quartz + Cristobalite | <12% by wt. |
| feldspar | |
| Cation exchange capacity | 75 meq/100 g |
| Content of Na⁺ in the CEC | 20% |

Two different variants of bentonite 1 were used:

TABLE A
Screen residues

| Property | Variant 1 | Variant 2 |
|---|---|---|
| Dry screen residue to: | <0.3% | 14% |
| 45 μm [% by wt.] | | |
| Wet screen residue: | <0.3% | 9.5% |
| 45 μm [% by wt.] | | |

The abovementioned bentonites were used in each case to produce slurries with 25% by weight solids based on dry bentonite (determined by water content determination after drying to constant weight at 130° C.), which were characterized by their viscosity.

Variant 2 (different particle fineness) showed no great differences in the resulting viscosities.

TABLE 1
25% by weight of bentonite 1, variant 1, with 5% Polyglykol 4000

| Viscosity measurement (after | |
|---|---|
| production of the slurry) | |
| Spindle 3 | |
| 5 rpm | 3000 |
| 50 rpm | 680 |
| Spindle 5 | |
| 5 rpm | 3900 |
| 20 rpm | 1480 |
| 100 rpm | 600 |
| pH | 8.4 |

As table 1 shows, Polyglykol 4000 was suitable for producing concentrated slurries.

In a further test, the pH of the slurry was therefore adjusted to 7 with hydrochloric acid. After the dissolution of the polyethylene glycol, the acid was initially charged before the addition of the bentonite.

TABLE 2a
25% by weight of bentonite 1, variant 1, with 5% Polyglykol
4000, pH adjusted to 7 with hydrochloric acid

| Viscosity | | |
|---|---|---|
| measurement | New | after 1 day |
| Spindle 3 | | |
| 5 rpm | 3220 | 7740 |
| 50 rpm | 390 | 900 |
| Spindle 5 | | |
| 5 rpm | 3440 | 8560 |
| 20 rpm | 940 | 2220 |
| 100 rpm | 240 | 520 |
| pH | 7.4 | 7.5 |

To achieve a particularly good storability of the slurries, it was advantageous to initially charge the hydrochloric acid and not to add it subsequently.

For comparison, measurements with 2 commercial dispersants from CIBA (Grenzach), the products Dispex® N40 and A40, were carried out.

TABLE 3
25% by weight of bentonite 1, variant 1, with 5%
Dispex ® N40 or 5% A40 as an additive

| | | |
|---|---|---|
| Viscosity | New | after 1 day |

| measurement | N 40 | A 40 | N 40 | A 40 |
|---|---|---|---|---|
| Spindle 3 | | | | |
| 5 rpm | 920 | 220 | n.m. | n.m. |
| 50 rpm | 574 | 224 | n.m. | n.m. |
| Spindle 5 | | | | |
| 5 rpm | 1120 | 240 | n.m. | n.m. |
| 20 rpm | 820 | 260 | n.m. | n.m. |
| 100 rpm | 692 | 270 | n.m. | n.m. |
| pH | 8.1 | 8.0 | n.m. | n.m. |

n.m. = not measureable

In the case of these additives, the concentration was varied between 0.2 and 5%. In all cases, initially low-viscosity slurries were obtained, which, however, gelled after 1 day. By way of example, table 3 shows the values for the slurries with 5% additive.

### Example 2

Bentonite 1 according to variant 1 from example 1 was used at a pH of 7 to investigate the influence of the molecular weight of the polyethylene glycol on the viscosity. The molecular weight was varied between 600 and 20000 g/mol.

TABLE 4
Slurries with 25% by weight of bentonite 1, variant
1, with Pluriol 600 (BASF) as an additive

| Viscosity | | | |
|---|---|---|---|
| measurement | New | after 1 day | after 14 days |
| Spindle 3 | | | |
| 5 rpm | 4240 | 10300 | 16800 |
| 50 rpm | 474 | 1060 | 1680 |
| Spindle 5 | | | |
| 5 rpm | 4800 | 10100 | 17000 |
| 20 rpm | 1260 | 2560 | 4360 |
| 100 rpm | 296 | 588 | — |
| pH | 6.9 | 7.4 | — |

TABLE 5
Same system as in table 4: with 5% Polyglykol
1500 (Clariant) as an additive

| Viscosity | | | |
|---|---|---|---|
| measurement | New | after 1 day | after 14 days |
| Spindle 3 | | | |
| 5 rpm | 3760 | 8400 | 14200 |
| 50 rpm | 418 | 900 | 1510 |
| Spindle 5 | | | |
| 5 rpm | 4080 | 8320 | 14200 |
| 20 rpm | 1100 | 2100 | 3780 |
| 100 rpm | 252 | 504 | 820 |
| pH | 6.9 | 7.3 | — |

TABLE 6
Same system as in table 4: with 5% Polyglykol
6000 (Clariant) as an additive

| Viscosity | | | |
|---|---|---|---|
| measurement | New | after 1 day | after 14 days |
| Spindle 3 | | | |
| 5 rpm | 3240 | 6440 | 10200 |
| 50 rpm | 370 | 710 | 1140 |
| Spindle 5 | | | |
| 5 rpm | 3440 | 6480 | 10200 |
| 20 rpm | 940 | 1740 | 2480 |
| 100 rpm | 224 | 408 | 600 |
| pH | 6.7 | 7.3 | — |

TABLE 7
Same system as in table 4: with 5% Polyglykol
20000 (Clariant) as an additive

| Viscosity | | | |
|---|---|---|---|
| measurement | new | after 1 day | after 14 days |
| Spindle 3 | | | |
| 5 rpm | 3180 | 5680 | 9420 |
| 50 rpm | 388 | 694 | 984 |
| Spindle 5 | | | |
| 5 rpm | 3360 | 5920 | 9120 |
| 20 rpm | 960 | 1600 | 2400 |
| 100 rpm | 236 | 416 | 556 |
| pH | 6.8 | 7.3 | — |

As the above tables 4 to 7 show, it was possible to use the polyethylene glycols (PEGs) over the entire molecular weight range which had been investigated beforehand to stabilize the bentonite investigated. The comparison of the viscosities as a function of the molecular weight showed that the higher molecular weights, even after the storage of the slurries, lead to low viscosities. The longer molecules with the greater average molecular weight were suspected to be bound more strongly to the surface and intercalated less strongly with time between the layers.

### Example 3

Bentonite according to example 1 which had been produced by an activation with 4.3% soda was used (bentonite 2). In accordance with the invention, this replaced all Mg²⁺ and Ca²⁺ ions of bentonite 1 with sodium ions.

It has been found that this bentonite 2 was likewise dispersible with polyethylene glycols by the process according to the invention. However, the required added amount, owing to the higher specific surface area available in the dispersion, rose to approx. 10%. The results of the viscosity measurements on the freshly produced slurries are shown in table 8, and a high viscosity rise was observed after a few days.

TABLE 8
Characteristic viscosity data of slurries of bentonite
2 (25% by weight) with 10% Polyglykol 4000

| Viscosity | |
|---|---|
| measurement | |
| Spindle 3 | |
| 5 rpm | 4280 |
| 50 rpm | 706 |
| Spindle 5 | |
| 5 rpm | 5280 |
| 20 rpm | 1540 |
| 100 rpm | 464 |
| pH | 9.8 |

### Example 4

The bentonite produced according to example 1, variant 1, was dispersed in a further inventive formulation with an acidic polyacrylate, Sokalan® CP 10 S from BASF. With this additive too, it was possible to produce storage-stable slurries with a bentonite concentration of 25% by weight by additions in the percentage range from, for example, 0.5 to 5%.

The Brookfield viscosities with spindle 5 at 100 rpm are shown below by way of example, as are the complete viscosity data for 1% addition. (Data for the additions based on the aqueous Sokalan CP 10S solution as obtained commercially.)

TABLE 9
Viscosities at 25% bentonite 1, and 1% and
2% Sokalan CP10S (Spindle 5, 100 rpm)

| Sokalan CP 10 S | | |
|---|---|---|
| concentration, | | |
| % by wt. based on bentonite | immediately | after 1 day |
| 2.5 | 44 | 156 |
| 1 | 48 | 328 |

TABLE 10
Complete viscosity data of the slurry
with 1% by weight of Sokalan CP 10S

| Viscosity | | |
|---|---|---|
| measurement | new | after 1 day |
| Spindle 3 | | |
| 5 rpm | 0 | 300 |
| 50 rpm | 52 | 326 |
| Spindle 5 | | |
| 5 rpm | 0 | 320 |
| 20 rpm | 0 | 300 |
| 100 rpm | 48 | 328 |
| pH | 6.6 | 7 |

For comparison, the corresponding sodium salt (Sokalan® CP 10) was tested as an additive. Although similarly low viscosities to those for the use of Sokalan® CP 10S were determinable here directly after the preparation, the slurry gelled after one day to form a gel which was no longer pourable.

TABLE 11
Viscosity data for a batch analogous to tables 9 and
10, except that Sokalan ® CP 10 (sodium salt)
was used instead of Sokalan ® CP 10 S.

| Viscosity | | |
|---|---|---|
| measurement | new | after 1 day |
| Spindle 3 | | |
| 5 rpm | 120 | No measurements |
| 50 rpm | 140 | possible owing to gel |
| | | formation |
| Spindle 5 | | |
| 5 rpm | 160 | |
| 20 rpm | 160 | |
| 100 rpm | 156 | |
| pH | 8.2 | |

These data showed that the polyacrylates in the acid form (protonated form) used in accordance with the invention had considerable advantages. The use of a sodium form leads, via sodium activation of the bentonite, to thickening. Surprisingly, this effect did not occur in the case of the acid form.

### Example 5

Two further bentonites were used, whose different properties are listed below:

TABLE 12
Properties of the two bentonites used

| | | Bentonite | Bentonite |
|---|---|---|---|
| Property | Unit | 3 | 4 |
| Montmorillonite content | [%] | 94 | 100 |
| (methylene blue method) | | | |
| Secondary mineral contents | [% by | | |
| (X-ray measurements) | wt.] | | |
| Quartz and crystobalites | | <3 | 1 |
| Calcite | | — | 1 |
| Feldspar | | — | — |
| pH at 5% by weight | | 8.5 | 9 |
| Cation exchange capacity | meq/100 g | 95 | 110 |
| Content of Na in the total | [%] | 56 | 32 |
| cation exchange capacity | | | |
| Screen residues | | | |
| Dry screen residue to 45 μm | [% by | 2.5 | 9.8 |
| | wt.] | | |
| Wet screen residue to 45 μm | [% by | 2.0 | 2.5 |
| | wt.] | | |

### Example 6

Bentonite 3 from example 5 was examined with regard to the production of highly concentrated slurries:

TABLE 13
Viscosity data of bentonite 3 with different contents of additives
(Polyglykols (PEGs) and Sokalan ® CP 10 S)

| | | |
|---|---|---|
| | | Brookfield |
| Content | | viscosity, |
| [% by | Storage | Spindle 5 |

| Additive | wt.] | pH | time | 20 rpm | 100 rpm |
|---|---|---|---|---|---|
| Polyglykol | 2.5 | 8.1 | 0 | 2700 | 700 |
| | | | 1 day | 6650 | 1670 |
| | 5 | 8.2 | 0 | 2460 | 676 |
| | | | 1 day | 5600 | 1520 |
| Sokalan | 1 | 5.7 | 0 | 300 | 316 |
| CP 10S | | | 1 day | 1640 | 1980 |
| | 2.5 | 4.7 | 0 | 380 | 220 |
| | | | 1 day | 1640 | 960 |

The data of table 13 showed that it was possible to formulate bentonite 3 as a highly concentrated slurry with the inventive additives. In spite of the different percentage contents of polyethylene glycol and of the polyacrylate, the tests showed continued storage stability and no gelation of the slurries.

### Example 7

As a further variant, slurry production with bentonite 4 from example 5 was examined. This was likewise used in a concentration of 25% by weight based on the dry substance.

TABLE 14
Viscosity data of bentonite 4 with different contents of additives,
Polyglykols (PEGs) and Sokalan ® CP 10 S

| | | | | Brookfield | |
|---|---|---|---|---|---|
| | Content | | | viscosity | |
| | [% by | | Storage | Spindle 5 | |
| Additive | wt.] | pH | time | 20 rpm | 100 rpm |
| Polyglykol | 5 + 16% | 7.0 | 0 | 3540 | 832 |
| 4000 + | | 7.5 | 1 day | 5400 | 1210 |
| hydrochloric | | | | | |
| acid | | | | | |
| Sokalan | 1 | 7.2 | 0 | 780 | 480 |
| CP 10S | | | 1 day | — | — |
| | 2.5 | 6.2 | 0 | 440 | 364 |
| | | | 1 day | 6200 | 2400 |

The data of table 14 show that the inventive slurries retained their positive properties even when a further bentonite (bentonite 4) was used. To achieve good and stable viscosities, the pH was preferably adjusted to values of <8.

### Example 8

As a further variant, it was attempted to produce a slurry according to example 1 (see also table 1), except that polyethylene glycols having a mean molecular weight of more than 100 000 were used. For example, PEGs with a mean molecular weight of 400 000 (Polyox™ WSR N 3000 and Polyox™ WSR 301, Dow Chemical Company) were used. It was not possible here to obtain a pourable slurry, but rather only a solid mass. This can be explained by high molecular weight PEGs, as a result of bridging flocculation, bonding individual bentonite particles, and thus not having viscosity-reducing action by virtue of steric stabilization.

1. A slurry comprising
a) at least 10% by weight of at least one sheet silicate, based on the total weight of the slurry;
b) an aqueous suspension medium; and
c) a dispersing aid selected from the group consisting of at least one polyethylene glycol having a mean molecular weight of less than 90 000, at least one polyacrylic acid in free acid form, and mixtures thereof.

2. The slurry as claimed in claim 1, characterized in that the at least one polyethylene glycol has a mean molecular weight of less than about 80 000.

3. The slurry as claimed in claim 1, characterized in that the at least one polyacrylic acid has a mean molecular weight between about 100 and 100 000.

4. The slurry as claimed in claim 1, characterized in that a proportion of divalent cations in the CEC of the at least one sheet silicate is at least 30%.

5. The slurry as claimed in claim 1, characterized in that the slurry, apart from components a), b) and c), does not have any component comprising monovalent metal cations.

6. The slurry as claimed in claim 1, characterized in that the pH of the slurry is between about 5 and 10.

7. The slurry as claimed in claim 1, characterized in that its pH is adjusted by addition of at least one acid.

8. The slurry as claimed in claim 1, characterized in that the at least one sheet silicate is a swellable sheet silicate.

9. The slurry as claimed in claim 1, characterized in that the at least one sheet silicate comprises a calcium-containing sheet silicate.

10. The slurry as claimed in claim 1, characterized in that the at least one sheet silicate comprises a smectitic sheet silicate.

11. The slurry as claimed in claim 1, characterized in that the content of monovalent metal ions and ammonium ions contained therein is less than 0.5% by weight, not including the content of the at least one sheet silicate of monovalent metal ions and ammonium ions.

12. The slurry as claimed in claim 1, characterized in that the at least one sheet silicate is selected from the group consisting of a bentonite, hectorite, saponite, beidelite or mixtures thereof.

13. The slurry as claimed in claim 4, characterized in that the divalent cations in the at least one sheet silicate comprise calcium or magnesium ions.

14. The slurry as claimed in claim 1, characterized in that the a proportion of monovalent cations, in the CEC of the at least one sheet silicate is less than 65%.

15. The slurry as claimed in claim 1, characterized in that the CEC of the at least one sheet silicate is more than 70 meq/100 g.

16. The slurry as claimed in claim 1, characterized in that the content in the slurry of the at least one sheet silicate is more than 15% by weight.

17. The slurry as claimed in claim 1, characterized in that the aqueous suspension medium is selected from the group consisting of water, an aqueous alcoholic solution, a glycol-containing aqueous solution and mixtures thereof.

18. The slurry as claimed in claim 1, characterized in that the at least one polyethylene glycol is used in an amount between about 0.1 to 10% by weight, based on the at least one sheet silicate.

19. The slurry as claimed in claim 1, characterized in that the at least one polyacrylic acid is used in an amount between about 0.1 and 10% by weight, based on the at least one sheet silicate.

20. A process for producing a slurry comprising charging at least one dispersing aid in an aqueous suspension medium, adding an acid to the medium to adjust the pH thereof, and then adding at least one sheet silicate to form the slurry.

21. (canceled)

22. (canceled)

23. (canceled)

24. (canceled)

25. A process for forming a liquid washing or cleaning composition, especially a liquid washing composition or fabric softener composition, comprising using the slurry of claim 1.

26. A composition utilized in the field of the paper industry, especially in contaminant control, in retention aids, or as a thickener, or an adsorbent, comprising the slurry of claim 1.
